(19) United States
(12) Patent Application Publication
(10) Pub. No.: US 2007/0227963 A1
(43) Pub. Date: Oct. 4, 2007

(54) Fluid filter element and bypass adaptor

(75) Inventors: Walter J. Fick, Kearney, NE (US); Thomas C. Richmond, Kearney, NE (US); James N. Marshall, Elm Creek, NE (US)

Correspondence Address: REINHART BOERNER VAN DEUREN P.C., 2215 PERRYGREEN WAY, ROCKFORD, IL, 61107, US

(73) Assignee: Baldwin Filters, Inc., Kearney, NE (US)

(21) Appl. No.: 11/394,918

(22) Filed: Mar. 31, 2006

(51) Int. Cl. B01D 21/24

(52) U.S. Cl. 210/433.1; 210/450; 210/451; 210/455

(57) ABSTRACT

A fluid filter arrangement is provided. The fluid filter arrangement includes a filter cartridge having a ring of filter media sealingly bonded to first and second end caps. The first and second end caps having first and second openings, respectively, fluidly communicating with the interior of the ring of filter media. The second end cap includes a seal surrounding the second opening. The fluid filter arrangement further includes an adaptor having at least one housing mount on the external side and an annular flange having a valve seat on the internal side. The adaptor is sealingly mates with the second the end cap.

### FIELD OF THE INVENTION

This invention generally relates to fluid filter arrangements, more particularly, to fluid filter arrangements that include a fluid bypass which allows fluid to bypass the filter media under excessive pressure conditions.

### BACKGROUND OF THE INVENTION

Fluid filters incorporating fluid bypasses are well known in the art. Typically, the bypass incorporates a pressure relief valve that acts to allow dirty fluid to short-circuit the filter media of the filter under high pressure events. For example, short-circuiting is permitted when the filter media becomes sufficiently clogged with contaminants that have been filtered from the fluid. Such contaminant restriction will lead to an insufficient amount of fluid flowing through the filter. Although it is not typically preferred to allow unfiltered fluid to flow through the filter without being filtered, it is more preferable to allow a sufficient amount of lubrication fluid (or other fluid) to flow through the system to ensure proper lubrication of moving components. Otherwise, restricting the amount of lubrication fluid to an insufficient amount can result in catastrophic engine failures.

One example of such a fluid filter arrangement with a fluid bypass is disclosed in U.S. Pat. No. 5,770,054 to Wilhelm Ardes. The '054 patent to Ardes includes a filter element with an upper plastic end cap providing a bypass valve seat that seats against a valve on a standpipe in a housing. The filter element also includes a lower plastic end cap that carries a felt gasket. There are various drawbacks associated with Ardes, including significantly that different end cap structures are required for the upper and lower end caps. Also Ardes requires precise alignment between end caps is required to position the valve seat of the upper end cap, considering a plastic valve seat is utilized. The present invention relates to improvements over Ardes and the current state of the art in fluid filters that incorporate a fluid bypass.

### BRIEF SUMMARY OF THE INVENTION

According to an aspect of the present invention, a fluid filter arrangement includes an adaptor for adapting a housing (such as the housing disclosed in Ardes) to provide for a fluid bypass through the housing components, and a more simplified filter cartridge (a.k.a. filter element) for use therewith. The filter cartridge includes a tubular ring of filter media having opposing first and second ends sealingly bonded to first and second end caps, respectively. The first and second end caps define first and second openings, respectively. The second end cap forms a seal that surrounds the second opening. The fluid filter arrangement further includes an adaptor having external and internal sides and defining a bypass port therethrough. The adaptor has at least one housing mount on the external side for mounting the adaptor to the housing; and an annular flange having a valve seat on the internal side. The adaptor does not carry a valve, but can be used in connection with a housing that provides a standpipe with a valve. The adaptor mates with the second end cap and engages the seal.

A further feature of one embodiment of the present invention is the provision for multi-component end caps which are potted to the filter media and integrally provide a seal. The same end cap components may be used for both upper and lower end caps, which at the same time providing seals at both locations.

According to another claimed aspect, a fluid filter arrangement includes an adaptor for adapting a housing to provide for a fluid bypass through the housing components, and a more simplified filter cartridge for use therewith. The filter cartridge includes a tubular ring of filter media having opposing first and second ends sealingly bonded to first and second end caps, respectively. The first and second end caps define first and second openings, respectively. The adaptor has external and internal sides and defines a bypass port therethrough. The adaptor has at least one housing mount on the external side for mounting to the housing and an annular flange having a valve seat on the internal side. The adaptor does not carry a valve and is sealingly received into the second opening of the second end cap. The adaptor has an outer periphery sized smaller than an outer periphery of the second end cap.

It is a feature of the present invention that the a combination of a housing adapter and filter element can provide potential advantages such as replacing fewer parts at each filter change, thereby reducing waste and costs. The present invention also provides the opportunity for a more simplified filter element, again lowering material and capital costs, especially in the instance where the same components are used for both the upper and lower end caps. An additional advantage is improved serviceability. For example, it is a feature of an embodiment that the installation and removal means for attaching the filter element to the housing lid can be changed from a difficult snap fit to a relatively easy push and slide radial fit onto the housing adapter. This can significantly ease filter change out and reduce contact with filtered fluids, such as used lubrication oil.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional view of an exemplary embodiment of a fluid filter arrangement constructed in accordance with the teachings of the present invention;

FIG. 2 is an enlarged partial cross-sectional view of the housing adaptor and the filter cartridge of FIG. 1 wherein the second end cap sealingly receives the housing adaptor;

FIG. 3 is a perspective view of the housing adaptor in FIG. 2;

FIG. 4 is a partial cross-sectional view of a filter cartridge in combination with another embodiment of an adaptor in accordance with the teachings of the present invention;

FIG. 5 is a perspective view of the adaptor of FIG. 4;

FIG. 6 is a partial cross-sectional view of a filter cartridge in combination with a further embodiment of an housing adaptor in accordance with the teachings of the present invention;

FIG. 7 is a partial cross-sectional view of a filter cartridge in combination with a further embodiment of an adaptor in accordance with the teachings of the present invention; and

FIG. 8 is a partial cross-sectional view of a filter cartridge in combination with a further embodiment of an housing adaptor in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

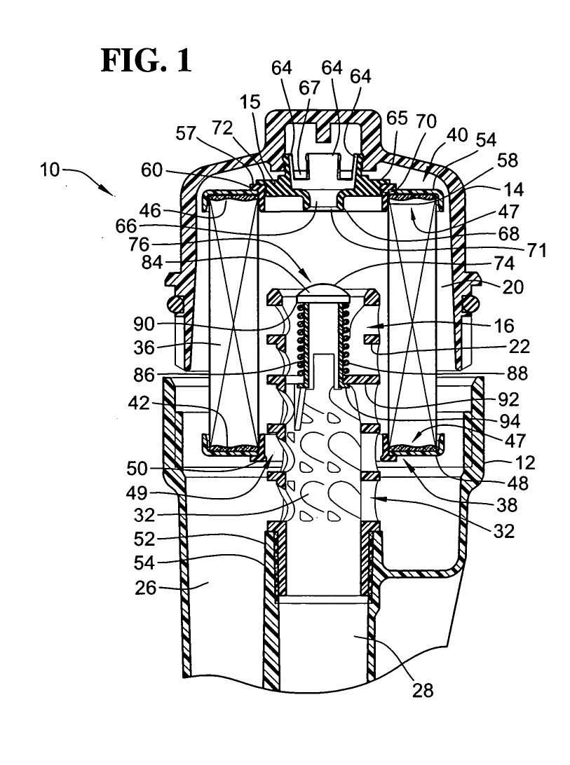

A fluid filter arrangement 10 in accordance with the present invention is illustrated in FIG. 1. The fluid filter arrangement 10 includes a housing 12 in the form of a canister with a housing lid 14, a housing adaptor 15, and a bypass valve 16. The filter arrangement 10 also includes a filter cartridge 18 for use with the housing components. The housing lid 14 threadedly connects to the housing 12 to provide an interior cavity 20. The stand pipe 22 extends vertically upwards from the housing 12 into the interior cavity 20. The stand pipe 22 includes the bypass valve 16 therein. The filter cartridge 18 is releasably attached to the housing lid 14 by the housing adaptor 15 and located within the interior cavity 20. In an assembled condition, the filter cartridge 18 is installed between the housing lid 14 and the housing 12 and surrounds the stand pipe 22.

The housing 12 includes an inlet 26 and an outlet 28 to the cavity 20. When the fluid filter arrangement 10 is assembled, the filter cartridge 18 is inserted into the cavity 20, the inlet 26 is in fluid communication with the exterior of the filter cartridge 18 and the outlet 28 is in fluid communication with the interior of the cartridge 18. Specifically, the outlet 28 is in fluid communication with the interior of the cartridge 18 through a plurality of ports 32 in the stand pipe 22 which, after assembly, are positioned within the interior of the filter cartridge 18.

The filter cartridge 18 includes a ring of filter media 36 with opposed ends. The filter media 36 provides an interior volume which can be occupied in part with a tubular support (not shown) if desired to support the ring of filter media or left empty. In any event, the interior volume of the filter media 36 provides sufficient clearance to receive the standpipe 22. Bottom and top end caps 38, 40 are sealingly bonded to first and second ends 42, 44 of the filter media 36, respectively. The end caps 38, 40 may be formed of plastic or can be a combination of materials such as plastic and rubber material. The end caps 38, 40 are sealingly bonded to the ring of filter media 36 by a potting material 46 such as plastisol. Specifically, opposed ends of the ring of filter media 36 are received in annular wells 47 provided by a bottom and inner and outer axially extending walls of the end caps 38, 40. Other alternative seal bonding techniques may be used and include plastic welding techniques or other such bonding means so as to prevent short circuiting of fluid between the filter media and the end cap.

In an embodiment, the end caps are comprised of two components assembled together. For example, the bottom end cap 38 includes an L-shaped end plate 48 and an annular gasket 50, which are assembled together. It should be noted that the present invention will be described with reference to end plates having an L-shape. However, it is contemplated that substantially flat end plates could also be used in accordance with the teachings of the present invention. The gasket 50 is sealingly received into a central hole in the end plate 48 with an interference fit therebetween. The gasket 50 surrounds and provides an opening 49 of the bottom end cap 38. The gasket 50 is adapted to create a seal between the bottom end cap 38 and the housing 12 when the filter cartridge 18 is installed over the standpipe 22. Particularly, the gasket 50 provides a radial seal between the outer surface 52 of a base portion 54 of the housing 12 from which the standpipe 22 extends and through which the outlet 28 is provided and the L-shaped end plate 48. The standpipe 22 extends into the interior of the filter cartridge 18 via the first opening 49 provided by the gasket 50.

The L-shaped end plate 48 is preferably made from a substantially rigid material and more preferably from a plastic, but may also comprise metal or an alternative incinerable material. It will be appreciated that the gasket 50 prevents fluid from short-circuiting the filter cartridge 18 and preferably is an elastomeric material (which is meant to include natural and/or synthetic rubber and/or other elastomeric materials that are resiliently rubber-like or resiliently flexible). The end plate 48 and the gasket 50 are assembled together prior to potting the end caps to the filter media with plastisol. Together, the end plate 48 and the gasket 50 provide the annular well 47, which provides a receptacle to receive viscous plastisol material which solidifies and bonds the end cap to the end of the ring of filter media 42.

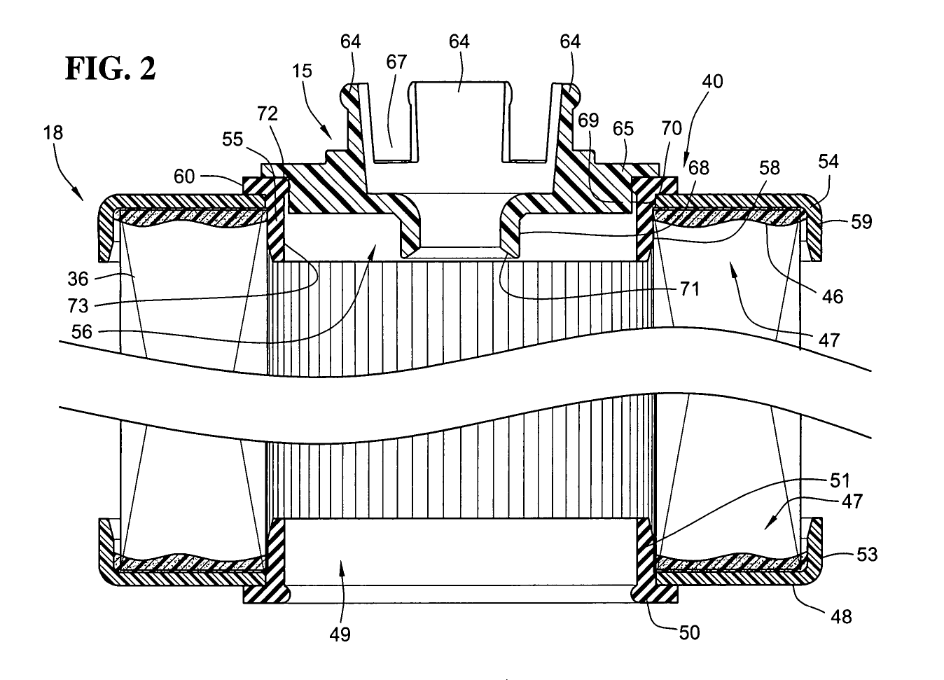

As best illustrated with reference to FIGS. 1 and 2, in this embodiment, the top end cap 40 is the same as the bottom end cap 38. As a result, the same end cap components can be used to form both the top and bottom end caps. The same molds can be used to form the respective end cap components, thus avoiding the need for additional manufacture and inventory of completely different components. As a result, there may be no difference between top and bottom ends of the filter cartridge such that either end can be used to seal against the stand-pipe and the other end used to seal against the adaptor. As used herein, top is used to identify the end cap which is ultimately receives an adaptor.

Because the end caps are made of the same components, the top end cap 40 also includes an L-shaped end plate 54 and a gasket 55 sealingly received by a hole in the L-shaped end plate 54. The gasket 55 also provides an opening 56 in fluid communication with the interior of the filter cartridge 18.

The housing adaptor 15 is adapted to be releasably connected to the housing lid 14 and to the filter cartridge 18. To provide the releasable connection, in an embodiment, the housing adaptor 15 includes a plurality of prongs 64 projecting vertically upwards axially from an exterior side of a main disc portion 65. The prongs 64 are adapted to snap onto corresponding engagement means of the housing lid 14, particularly engagement means such as ribs, channels, ridges, or merely a sufficiently small cavity, relative to an outer periphery established by the prongs 64, of the housing lid 14. The prongs 64 surround a passage 66 extending axially through the housing adaptor 15 and are radially spaced apart providing gaps 67 between adjacent prongs 64. The passage 66 provides fluid communication to the fluid bypass. Thus, the passage 66 is in fluid communication with dirty fluid entering the cavity 20 via the gaps 67 between the prongs 64. The illustrated embodiment is described as having prongs 64 to engage the housing lid 14, however, the invention is not limited to having only prongs 64 and may include alternative connecting means to secure the housing adaptor 15 to the engagement means of the housing lid 14.

The housing adaptor 15 is adapted to releasably and sealingly secure the housing adaptor 15 to the top end cap 40 of the filter cartridge 18. An outer surface 70 of a portion 69 of the housing adaptor 15 is received into and seats with the opening 56 of the top end cap 40 provided by the gasket 55 creating an interference friction fit and seal there between. Specifically, the compression or deflection due to the resiliency in the rubber material of the end cap gasket preferably creates a sufficient force to releasably hold the filter cartridge 18 on the housing adaptor 15.

To assist with the sealing and retention functions, the gasket 55 may include an annular rib 72 that extends radially inward from an inner surface 73 of the gasket 55. The annular rib 72 focuses the seal between the outer surface 70 of portion 69 of the housing adaptor 15 and the gasket 55 by resiliently compressing when the housing adaptor 15 is inserted into the opening 56 of the gasket 55.

Furthermore, an interior side of the main disc portion 65 abuts a top surface of the gasket 55 to axially position the housing adaptor 15 relative to the top end cap 40. The abutment between the disc portion 65 and the top surface of the gasket 55 may also be used to provide the seal between the housing adaptor 15 and the gasket 55. In this embodiment, the outer diameter of the disc portion 65 of the housing adaptor 15 is smaller than the outer diameter of the top end cap 40.

On an interior side, the housing adaptor 15 includes an inner annular flange 68 that depends axially downward and has a valve seat 71. In this embodiment, the inner annular flange 68 is chamfered to improve the seal of the seat 71 between the housing adaptor 15 and a domed surface 74 of a valve member 76 of the bypass valve 16 (see FIG. 1). The passage 66 extending through the housing adaptor 15 is partially provided by the inner annular flange 68.

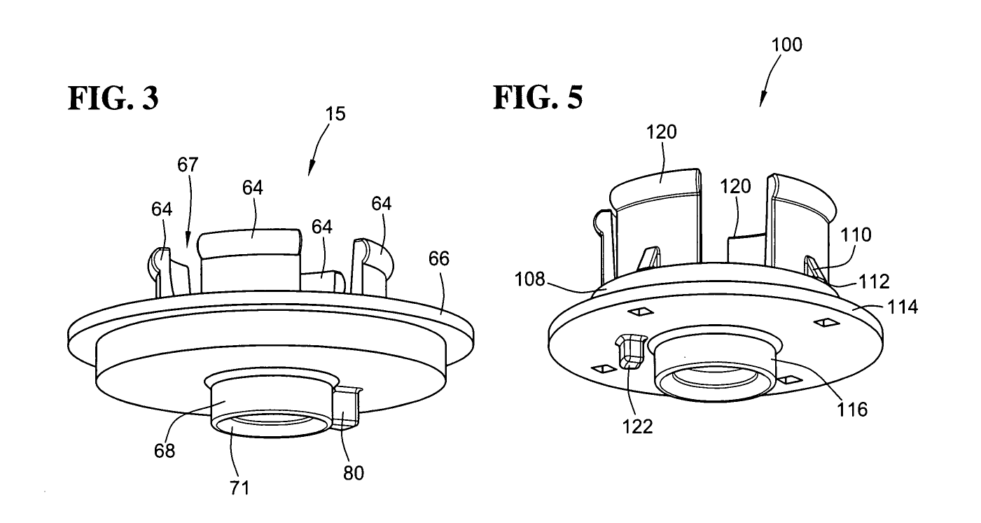

In an embodiment and shown in FIG. 3, the housing adaptor 15 includes a key 80 that extends radially outward from the inner annular flange 68. Alternatively, the key 80 could extend vertically downward from an interior side of the housing adaptor 15, see for example key 122 in FIG. 5. The key 80 can be used to angularly align the filter cartridge 18 relative to a stand pipe 22, and unlock a latch (not shown) if provided on the standpipe. Such latched valve devices are known for example as disclosed in U.S. Pat. No. 6,554,139 to Maxwell et al. In any event, the housing as adapted by the reusable adaptor disables this latch device if it is present. It will be appreciated that more than one key may be used if required.

As shown in FIG. 1, the stand pipe 22 extends from and is secured to a base 54 of the housing 12. The stand pipe 22 may be any metal, plastic or other rigid material. The stand pipe 22 may be adhesively, threadedly or frictionally secured to the base 54. The stand pipe 22 carries the filter bypass valve 16.

The bypass valve 16 includes a mushroom shaped valve member 76 that includes a head 84 and a shaft 86 and is resiliently biased by a coil spring 88. The head 84 is dome shaped and provides the domed top surface 74 and a flat bottom surface 90. It is contemplated that the head 84 could be a flat disc without the domed surface 74. If the head 84 is in the form of a flat disc or other shape, the axial annular flange 68 of the housing adaptor 15 would be more appropriately configured to seal to the flat disc. The shaft 86 is substantially cylindrical in shape and extends vertically downward from the head 84, however, in other embodiments the shaft could form other shapes.

The coil spring 88 is carried by and surrounds the shaft 86. The coil spring 88 is positioned axially between the head 84 and a support flange 92 attached to and radially extending inward from the stand pipe 22. Particularly, one end of the coil spring 88 abuts the bottom surface 90 of the head 84 and the other end abuts a top side of a support flange 92 to resiliently bias the valve member 76 vertically upwards. The end of the shaft 86, opposite the end that is attached to the head 84, includes a plurality of fingers 94 that extend radially outward from the shaft 86 and selectively abut a bottom side of the support flange 92 to connect the valve member 76 to the stand pipe 22. The portion of the shaft 86 that includes the fingers 94 may be resiliently biased radially inward such that during installation the valve member 76 may be snap fit into the support flange 92 of the stand pipe 22.

The filter arrangement 10 is assembled by releasably snapping on the housing adaptor 15 to the housing lid 14 via the snap prongs 64 and also releasably securing the housing adaptor 15 to the filter cartridge 18. The combination of the housing lid 14, housing adaptor 15 and filter cartridge 18 is then positioned over the stand pipe 22 such that the stand pipe 22 is received into the interior of the filter cartridge 18 through the first opening 48 in the bottom end cap 38. Particularly, the stand pipe 22 is received through the hole in the gasket 50 inserted into the first opening 48 of the bottom end cap 38. After the housing lid 14 bottoms out on the housing 12, the housing lid 14 is then screwed to the housing 12. As the housing lid 14 is screwed to the housing 12, the gasket 50 of the bottom end cap 38 seats to the outer surface 52 of the base 54 to prevent short-circuiting of fluid from the dirty side of the filter to the clean side of the filter.

Furthermore, as the housing lid 14 is screwed to the housing 12, the housing adaptor 15 seats with the valve member 76. Particularly, the beveled inner annular flange 68 seats on the domed surface 74 of the head 84. As the inner annular flange 68 seats to the head 84, the coil spring 88 may begin to compress vertically downward. It will be appreciated that the seat between the inner annular flange 68 of the housing adaptor 15 and the domed surface 74 of the head 84 creates a seal that prevents dirty fluid from short-circuiting the filter cartridge 18 through the top end cap 40.

In operation, the bypass valve 16 acts to selectively allow dirty fluid to short-circuit the filter cartridge 18 during high pressure situations. One specific high pressure situation is when the filter media 36 has become sufficiently plugged with filtered contaminates such that an insufficient amount of fluid may flow through the filter media 36. Furthermore, as the filter media 36 becomes increasingly plugged with filtered contaminates, the pressure differential across the filter media 36 between the high pressure dirty fluid side and lower pressure clean fluid side increases. The bypass valve may open at other high pressure situations such as cold startup when the filtered fluid may be thicker than at normal operating temperatures.

At some predetermined pressure differential, the load created by the dirty fluid acting on the domed surface 74 of the head 84 will be greater than the load acting on the bottom surface 90 of the head 84 by the coil spring 88 and the clean fluid such that the valve member 76 will be actuated and move vertically downward. As the valve member 76 moves vertically downward, the inner annular flange 68 and the head 84 no longer contact, thereby opening the bypass valve 16, allowing dirty fluid to short circuit the filter cartridge 18. It will be appreciated, that the predetermined pressure differential at which the bypass valve 18 will open can be varied by providing a coil spring 88 with a different stiffness.

The connection between the housing adaptor 15 and the top end cap 40, particularly the gasket 55 of the top end cap 40, explained previously, provides for a relatively easy replacement of a spent or clogged filter cartridge 18. After the housing lid 14 and filter cartridge 18 attached thereto via the housing adaptor 15 are removed from the housing 12, the spent filter cartridge 18 may be pulled away from and disconnected from the housing adaptor 15. The housing adaptor 15 has a stronger snap-on connection than the interference fit between the cartridge and housing adaptor, such that the housing adaptor 15 remains secured to the housing lid 14 for reuse. A new clean filter cartridge 18 can then be slid onto and connected to the housing adaptor 15. Specifically, one of the end caps of the new filter cartridge is placed onto the housing adaptor 15.

It will be appreciated that the reusable housing adaptor 15 allows simpler and more economical filter cartridges to be manufactured because in an embodiment both end caps 38, 40 are identical and the more complex structure, the housing adaptor 15, needs only to be manufactured a single time and not continually manufactured and provided with each replacement filter cartridge.

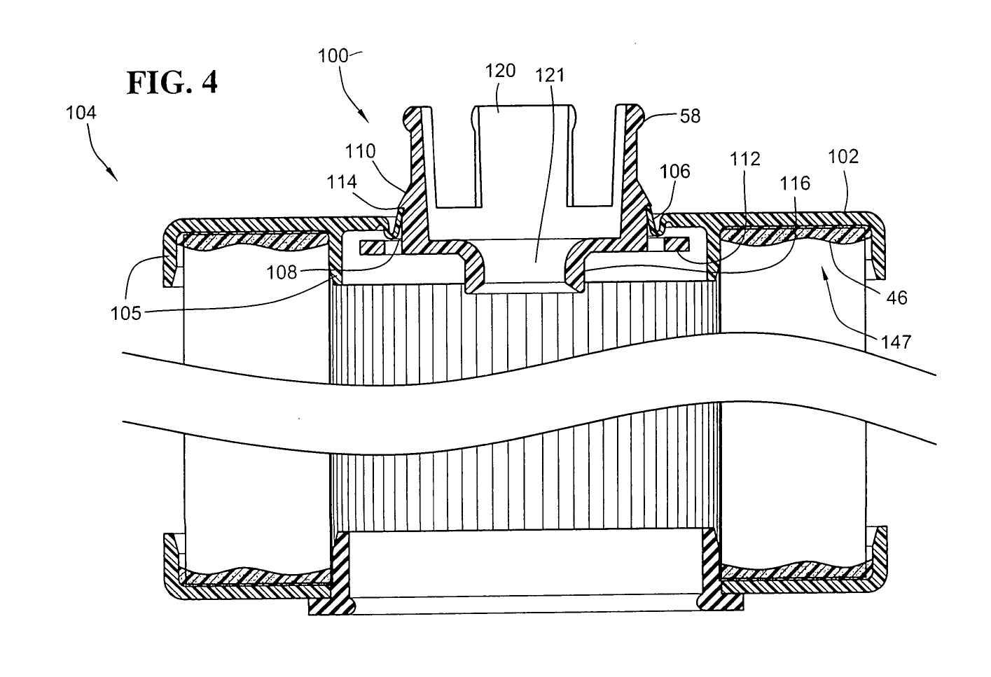

An alternative embodiment of an adaptor in accordance with the present invention is provided in FIGS. 4 and 5. The adaptor 100 is sealingly received in an opening in the top end cap 102 of the filter cartridge 104. The top end cap 102 in this embodiment is different than the top end cap 40 of the previous embodiment. In this embodiment, the well 147 in which the filter media is sealingly bonded at the upper end is provided by two integral annular walls that depend axially from the end cap 102, rather than by different walls depending from the cap 54 and the gasket 55, respectively.

Furthermore, the opening in the top end cap 102 is provided by an annular sealing lip 106 which is formed into the plastic material of the top end cap 102. The reduced thickness and curved shaped of the sealing lip 106 provides for resilient deflection of the sealing lip 106 for providing a wiper/lip seal. The sealing lip 106 engages and seals with the adaptor 100 when the adaptor 100 is received by and inserted into the opening of the top end cap 102. The sealing lip 106 presses radially inward against a radially outer surface 108 of the adaptor 100 to engage and secure the adaptor 100 therein as well as create a radial seal therebetween. In this embodiment, the sealing lip 106 is tapered inward to also provide a deflection means to assist when installing the adaptor 100.

In an embodiment, the adaptor 100 includes a plurality of wedge shaped catches 110 vertically spaced apart from a radially extending annular flange 112. The catches 110 and the annular flange 112 facilitate a snap-on connection of the adaptor 15 to the sealing lip 106. The sealing lip 106 abuts with the bottom shoulder 114 of the protrusions 110 vertically above the sealing lip 106 and with the radial annular flange 112 vertically below the sealing lip 106.

However, because the sealing lip 106 creates a radial seal with the outer surface 108 it is contemplated that in an embodiment the sealing lip 106 and outer surface 108 can create a sufficiently tight friction fit that the snap-on catches 110 are not required.

The radial annular flange 112 provides the additional function of preventing the adaptor 100 from being pushed completely through the opening in the top end cap 102 during assembly. As the adaptor 100 is appropriately positioned and seated within the opening, the radial annular flange 112 bottoms out on the bottom of the sealing lip 106 to prevent further axial movement. The radial annular flange 112 further prevents the adaptor 100 from being pushed out of position when the axial annular flange 116 seats with a valve member, as explained previously.

The adaptor 100 includes a plurality of vertically extending prongs 120. These prongs 120 are adapted to secure the adaptor 100, and the filter cartridge 104 to which it is attached, to a filter housing, as shown and described previously in association with the first embodiment. The prongs 120 are radially spaced apart from one another and surround a passage 121 provided by the axial annular flange 112. The passage 121 provides fluid communication with the valve bypass. When the axial annular flange 116 is seated on a valve member (not shown) the passage 121 allows fluid to act on the valve member.

As illustrated in FIG. 5, the adaptor 100 may include a key 122 on an interior side. The key 122 extends vertically downward from an interior side of the radial annular flange 112. However, similar to the previous embodiment, the key 122 could extend radially from the axial annular flange 116. The key 122 may function to properly align the filter cartridge 104 relative to a stand pipe or unlock a latch (not shown) if provided on the standpipe. The adaptor 100 may include a plurality of keys 122.

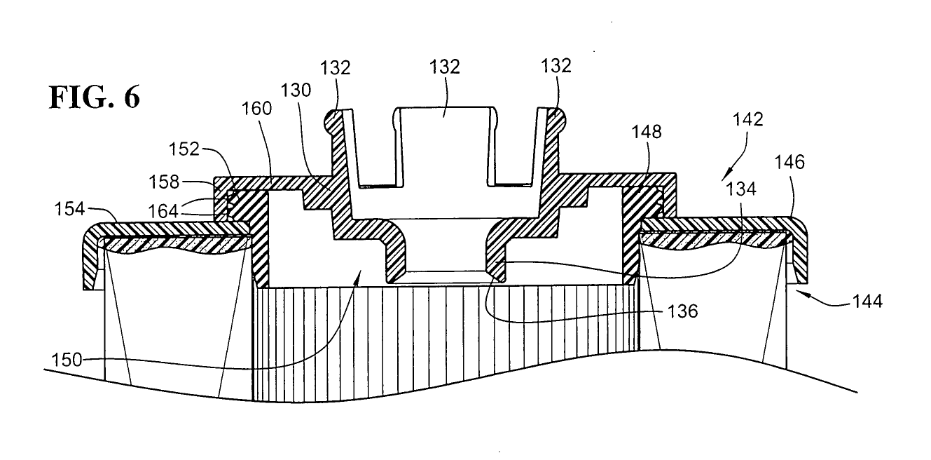

FIG. 6 illustrates an alternative embodiment of a housing adaptor 130 in accordance with the present invention. The housing adaptor 130 is similar to the housing adaptor of FIG. 2 and includes a plurality of angularly spaced apart prongs 132 for securing the housing adaptor 130 to an external housing (see FIG. 1) and an inner annular flange 134 that has a valve seat 136. The housing adaptor 130 interacts with the top end cap 142 of the filter cartridge 144. The top end cap 142 includes an L-shaped end plate 146 and a gasket 148 sealingly received by a hole in the L-shaped end plate 146. The gasket 148 and end plate 146 may be potted to filter media, as explained previously. The gasket 148 includes an opening 150 in fluid communication with the interior of the filter cartridge 144. The inner annular flange 134 of the housing adaptor 130 passes through the opening 150 in the gasket 148.

The gasket 148 includes a head portion 152 that is annular and extends radially outward. The head portion 152 has a larger diameter than the hole in the L-shaped end plate 146 and abuts the top 154 of the L-shaped end plate 146. An axial seal may be provided between the head portion 152 and the top 154 of the L-shaped end plate 146.

The housing adaptor 130 includes an outer annular flange 158 that extends vertically. The outer annular flange 158 interacts with the head portion 152 of the gasket 148. The housing adaptor 130 may abut the top of the head portion 152 of the gasket 148 to provide an axial seal therebetween. The outer annular flange 158 engages the radially outer surface of the head portion 152 to secure the housing adaptor 130 to the end cap 142, and consequently the filter cartridge 144. A radial seal is formed between the outer annular flange 158 of the housing adaptor 130 and the head portion 152 of the gasket 148. To focus the engagement and seal between the head portion 152 and the outer annular flange 158, the radial outer surface of the head portion 152 includes one or more annular ribs 164 that compress and form a press-fit connection when the housing adaptor 130 is temporarily secured to the gasket 148.

The gasket 148 and the outer annular flange 158 of the adapter 130 have a sliding press-fit engagement. When a spent filter cartridge 144 is replaced and removed from the housing adaptor 130, the housing adaptor 130 will typically remain with the external housing lid, such that simply a new filter element cartridge 144 can be installed.

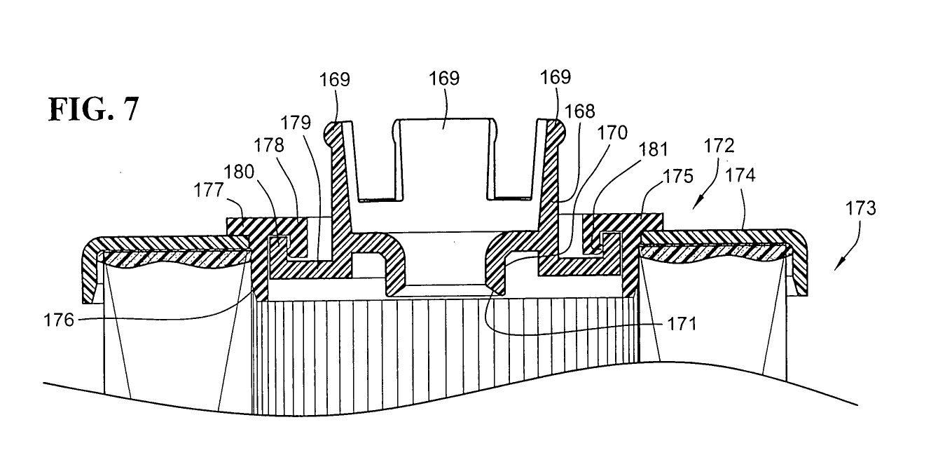

A further alternative embodiment of an adaptor according to the present invention is illustrated in FIG. 7. The adaptor 168 includes a plurality of angularly spaced apart prongs 169 for securing the adaptor to an external housing and an inner annular flange 170 that has a valve seat 171. The adaptor 168 interacts with the top end cap 172 of the filter cartridge 173. The top end cap 172 includes an L-shaped end plate 174 and a gasket 175 sealingly received by a hole in the L-shaped end plate 174. The gasket 175 includes an opening in fluid communication with the interior of the filter cartridge 173.

The gasket 175 includes a main body portion 176 that is sealingly received by the hole in the L-shaped end plate 174. An outer annular flange 177 extends radially outward from the main body portion 176. The outer annular flange 177 has a larger diameter than the hole in the L-shaped end plate 174 and abuts with the top of the L-shaped end plate 174 and may provide an axial seal therebetween. The gasket 175 further includes an inner flange 178 that extends radially inward from the main body portion 176 and is L-shaped.

The adaptor 168 includes an outer annular flange 179 that has an L-shaped cross-section. The outer annular flange 179 sealingly interacts with and engages the gasket 175. The outer annular flange 179 of the adaptor 168 includes an upward extending portion 180 that, in an assembled condition, is positioned radially between the main body portion 176 and the inner flange 178 of the gasket 175. The inner flange 178 may include an annular rib 181 that resiliently compresses to focus the seal and engagement between the gasket 175 and the adaptor 168. Alternatively, the annular rib 181 could extend from the main body portion 176 of the gasket 175.

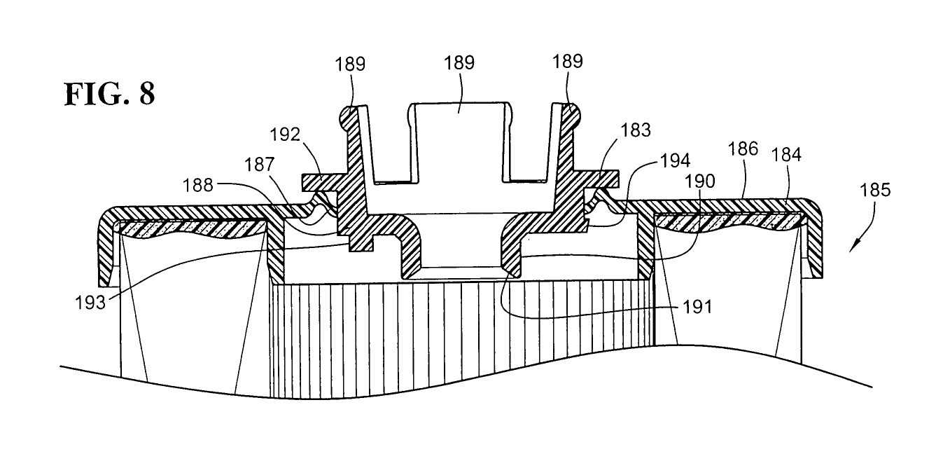

A further alternative embodiment of an adaptor in the form of a housing adaptor in accordance with the present invention is illustrated in FIG. 8. The housing adaptor 183 is similar in some respects to the adaptor 100 of FIG. 4. However, the housing adaptor 183 is sealingly received in an opening in the top end cap 184 of the filter cartridge 185 from a top side 186 rather than from a bottom side. The top end cap 184 includes a sealing lip 187 that engages and forms a radial seal between an outer surface of the housing adaptor 183.

The top end cap 184 and the sealing lip 187 in this embodiment are similar to the embodiment in FIG. 4. However, because the housing adaptor 183 inserts into the hole in the top end cap 184 from the top side 186, the taper of the annular sealing lip 187 of the top end cap 184 is reversed such that the sealing lip 187 tapers radially inward in a downward direction, as illustrated in FIG. 8.

The housing adaptor 183 is similar to previous embodiments, as it includes a plurality of angularly spaced apart prongs 189 for connecting the housing adaptor 183 to an external filter housing, as illustrated and described previously. Similarly, the housing adaptor 183 includes an inner annular flange 190 that has a valve seat 191.

The housing adaptor 183 further includes an outer annular flange 192 that extends radially outward from the housing adaptor 183. When the top end cap 184 receives the housing adaptor 183, the outer annular flange 192 abuts the sealing lip 187 to position the housing adaptor 183 relative to the top end cap 184.

As illustrated in FIG. 8, the housing adaptor 183 may include a key 193 on an interior side. The key 193 extends vertically downward from an interior side of the housing adaptor 183 and functions as explained previously.

Furthermore, in an embodiment, the housing adaptor 183 may include a plurality of wedge shaped catches 194 vertically spaced apart from the outer annular flange 192. The catches 194 facilitate a snap-on connection of the housing adaptor 183 to the sealing lip 187, as explained previously. However, it is contemplated that in an embodiment the engagement and friction fit between the sealing lip 187 and the housing adaptor 183 may be sufficiently strong that neither the outer annular flange 192 nor the wedge shaped catches 194 are required. However, in an embodiment, the engagement between the sealing lip 187 and the housing adaptor 183 is less than the connection between the prongs 189 and the external housing such that the housing adaptor 183 would remain with the housing when replacing a spent filter cartridge 185. This is thus a significant advantage over the embodiment of FIG. 4.

For clarity, annular as used herein is meant to include forming a ring or otherwise ring-shape including, but not limited to, circular, oval, rectangular or polygonal, or other shapes including a ring-like shape whether with flat or curved surfaces or a combination thereof.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fluid filter arrangement, comprising:
a tubular ring of filter media having opposing first and second ends;
a first end cap sealingly bonded to the first end of the filter media, the first end cap defining a first opening;
a second end cap sealingly bonded to the second end of the filter media, the second end cap defining a second opening;
a seal being formed by the second end cap and surrounding the second opening;
an adaptor having external and internal sides and defining a bypass port therethrough, the adaptor having at least one housing mount on the external side and a annular flange having a valve seat on the internal side but not carrying a valve on the adaptor, the adaptor mating with the second end cap and engaging the seal.

2. The fluid filter arrangement of claim 1, wherein the second end cap is a structurally composite end cap including outer and inner end cap components.

3. The fluid filter arrangement of claim 2, wherein the first end cap is structurally similar to the second end cap, wherein the same end cap components are used for both the first end cap and the second end cap.

4. The fluid filter arrangement of claim 2, wherein the inner end cap component comprises elastomeric material and forms the seal.

5. The fluid filter arrangement of claim 1, wherein the second end cap comprises an end plate comprising plastic material, the plastic end cap defining an annular sealing lip to provide said seal and define said second opening.

6. The fluid filter arrangement of claim 2, wherein the inner and outer end cap components cooperate to define an annular well receiving the second end of the filter media, with the outer component defining an outer annular wall, and the inner component defining an inner annular wall.

7. The fluid filter arrangement of claim 5, wherein the sealing lip is tapered radially inward.

8. The fluid filter arrangement of claim 1, wherein the adaptor includes at least one key extending axially from the internal side.

9. The fluid filter arrangement of claim 1, wherein the annular flange has a beveled valve seat.

10. The fluid filter arrangement of claim 2, wherein the adaptor includes an outer axially extending annular flange sealingly engaging a radially outer surface of the inner end cap component.

11. The fluid filter arrangement of claim 2, wherein the adaptor includes an annular outer flange, the inner end cap portion having at least two radially spaced apart annular walls, the annular outer flange sealing received between the at least two spaced apart annular walls and forming a radial seal with at least one of the at least two spaced apart annular walls.

12. The fluid filter arrangement of claim 1, wherein the fluid filter arrangement further includes:
a filter housing defining an inner cavity;
a stand pipe projecting into the cavity, the stand pipe having an end portion including a valve; and
wherein the standpipe is received through the first end cap and the standpipe extends into the interior of the filter media, and wherein the annular valve seat of the adaptor is in sealing engagement with the valve.

13. The fluid filter arrangement of claim 12, wherein the housing comprises a canister having a base end and an open end, and a lid removably secured to the open end, the lid comprising a snap connection means, the adaptor being removably snapped onto the lid via the snap connection means.

14. The fluid filter arrangement of claim 12, wherein the first end cap sealingly engages the standpipe. We could probably get rid of this claim

15. The fluid filter arrangement of claim 14, wherein the first end cap includes a seal to provide sealing engagement between the standpipe and the first end cap.

16. A fluid filter arrangement, comprising:
a tubular ring of filter media having opposing first and second ends;
a first end cap sealing bonded to the first end of the filter media, the first end cap defining a first opening;
a second end cap sealing bonded to the second end of the filter media, the second end cap defining a second opening; and
an adaptor having external and internal sides and defining a bypass port therethrough, the adaptor having at least one housing mount on the external side and an annular flange having a valve seat on the internal side but not carrying a valve, the adaptor mating with the second end cap, the adaptor having an outer periphery, the outer periphery being sized smaller than an outer periphery of the second end cap.

17. The fluid filter arrangement of claim 16, wherein the second end cap is a structurally composite end cap including outer and inner end cap components.

18. The fluid filter arrangement of claim 17, wherein the first end cap is structurally similar to the second end cap, wherein the same end cap components are used for both first end cap and the second end cap.

19. The fluid filter of claim 17, wherein the inner end cap component comprises an elastomeric material forming the seal.

20. The fluid filter arrangement of claim 16, wherein the second end cap comprises an end plate comprising plastic material and defining an annular well receiving the second end of the filter media, the plastic end cap defining an annular sealing lip to provide said seal and define said second opening.

21. The fluid filter arrangement of claim 20 wherein the adaptor includes a radially extending annular flange vertically spaced apart from at least one protrusion, the at least one protrusion including a shoulder, the sealing lip secured between the bottom shoulder and the radially extending annular flange.

22. The fluid filter arrangement of claim 16, wherein the annular flange has a beveled valve seat.

23. The fluid filter arrangement of claim 17, wherein outer and inner end cap components cooperate to define an annular well receiving the second end of the filter media, with the outer component defining an outer annular wall, and the inner component defining an inner annular wall.

24. The fluid filter arrangement of claim 17, wherein the adaptor includes an outer axially extending annular flange sealingly engaging a radially outer surface of the inner end cap component.

25. The fluid filter arrangement of claim 17, wherein the adaptor includes an annular outer flange, and the inner end cap portion includes at least two radially spaced apart annular walls, wherein the annular outer flange is sealing received between the at least two spaced apart annular walls and forms a radial seal with at least one of the at least two spaced apart annular walls.
